(19) United States
(12) Patent Application Publication
(10) Pub. No.: US 2013/0159665 A1
(43) Pub. Date: Jun. 20, 2013

(54) SPECIALIZED VECTOR INSTRUCTION AND DATAPATH FOR MATRIX MULTIPLICATION

(71) Applicant: Asheesh Kashyap, Plano, TX (US)

(72) Inventor: Asheesh Kashyap, Plano, TX (US)

(73) Assignee: Verisilicon Holdings Co., Ltd., Santa Clara, CA (US)

(21) Appl. No.: 13/327,519

(22) Filed: Dec. 15, 2011

(51) Int. Cl. G06F 9/30; G06F 9/38; G06F 9/302; G06F 15/76

(52) U.S. Cl. 712/3; 712/200; 712/E09.016; 712/E09.023; 712/E09.017; 712/E09.045

(57) ABSTRACT

A data processing element includes an input unit configured to provide instructions for scalar, vector and array processing, and a scalar processing unit configured to provide a scalar pipeline datapath for processing a scalar quantity. Additionally, the data processing element includes a vector processing unit coupled to the scalar processing unit and configured to provide a vector pipeline datapath employing a vector register for processing a one-dimensional vector quantity. The data processing element further includes an array processing unit coupled to the vector processing unit and configured to provide an array pipeline datapath employing a parallel processing structure for processing a two-dimensional vector quantity. A method of operating a data processing element and a MIMO receiver employing a data processing element are also provided.

### TECHNICAL FIELD

This application is directed, in general, to data processing and, more specifically, to a data processing element, a method of operating a data processing element and a MIMO receiver.

### BACKGROUND

MIMO detection is a computationally intensive part of wireless communications. In MIMO detection, the attenuation between a set of transmit and receive antennas is represented by a complex-valued matrix called a channel matrix. Given a received signal vector, the transmitted signal vector can be recovered by searching through a set of candidate vectors, which when multiplied by the channel matrix produce the received signal. However, current MIMO detection algorithms typically require the complex channel matrix to be converted to a “real” triangular matrix before the search is conducted. A triangular matrix is an inefficient structure from the standpoints of both storage and computational requirements since nearly half the elements are zero. For a vector processor, this produces wasted space within vector registers, and causes unnecessary toggling of multipliers. Improvements in this area would prove beneficial to the art.

### SUMMARY

Embodiments of the present disclosure provide a data processing element, a method of operating a data processing element and a MIMO receiver employing a data processing element.

In one embodiment, the data processing element includes an input unit configured to provide instructions for scalar, vector and array processing, and a scalar processing unit configured to provide a scalar pipeline datapath for processing a scalar quantity. Additionally, the data processing element also includes a vector processing unit coupled to the scalar processing unit and configured to provide a vector pipeline datapath employing a vector register for processing a one-dimensional vector quantity. The data processing element further includes an array processing unit coupled to the vector processing unit and configured to provide an array pipeline datapath employing a parallel processing structure for processing a two-dimensional vector quantity.

In another aspect, the method of operating a data processing element includes fetching instructions for scalar, vector and array processing and processing a scalar quantity through a scalar pipeline datapath. Additionally, the method includes also processing a one-dimensional vector quantity through a vector pipeline datapath employing a vector register and further processing a two-dimensional vector quantity through an array pipeline datapath employing a parallel processing structure.

In yet another aspect, the MIMO receiver includes a MIMO input element, coupled to multiple receive antennas, that provides receive data for scalar, vector and array processing. The MIMO receiver also includes a data processing element having an input unit that provides instructions for the scalar, vector and array processing, and a scalar processing unit that provides a scalar pipeline datapath for processing scalar data. The data processing element also has a vector processing unit, coupled to the scalar processing unit, that provides a vector pipeline datapath employing a vector register for processing one-dimensional vector data, and an array processing unit, coupled to the vector processing unit, that provides an array pipeline datapath having a parallel processing structure for processing two-dimensional vector data. The MIMO receiver further includes a MIMO output element, coupled to the data processing element, that provides an output data stream corresponding to the receive data.

The foregoing has outlined preferred and alternative features of the present disclosure so that those skilled in the art may better understand the detailed description of the disclosure that follows. Additional features of the disclosure will be described hereinafter that form the subject of the claims of the disclosure. Those skilled in the art will appreciate that they can readily use the disclosed conception and specific embodiment as a basis for designing or modifying other structures for carrying out the same purposes of the present disclosure.

### BRIEF DESCRIPTION

Reference is now made to the following descriptions taken in conjunction with the accompanying drawings, in which:

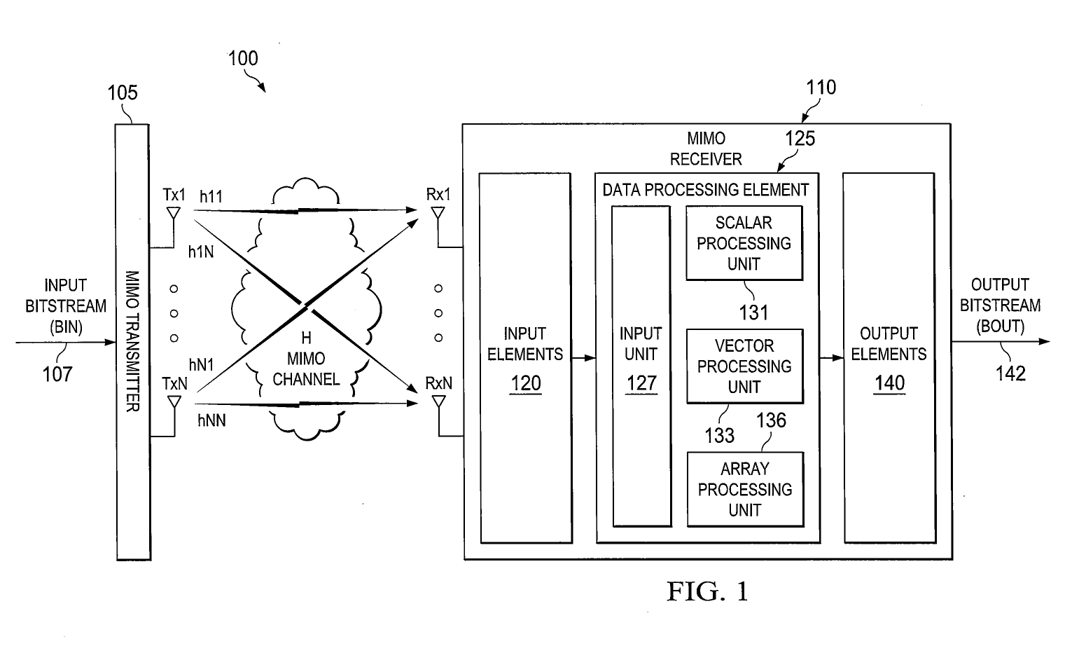

FIG. 1 illustrates a diagram of a MIMO system constructed according to the principles of the present disclosure;

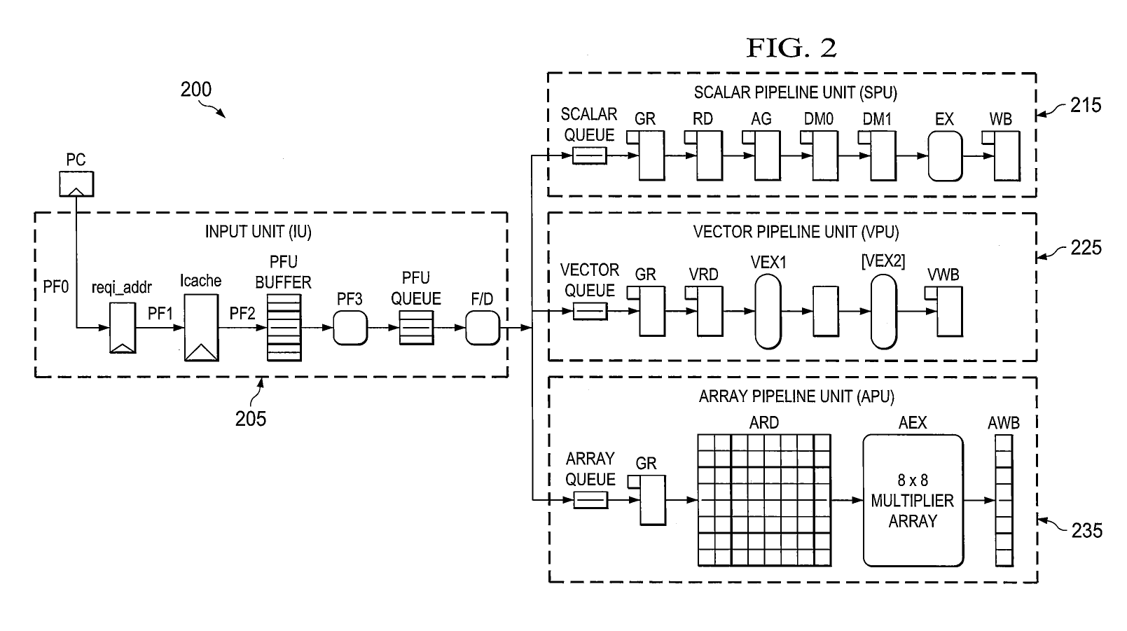

FIG. 2 illustrates a pipeline diagram of a data processing element as may be employed in the data processing element of FIG. 1;

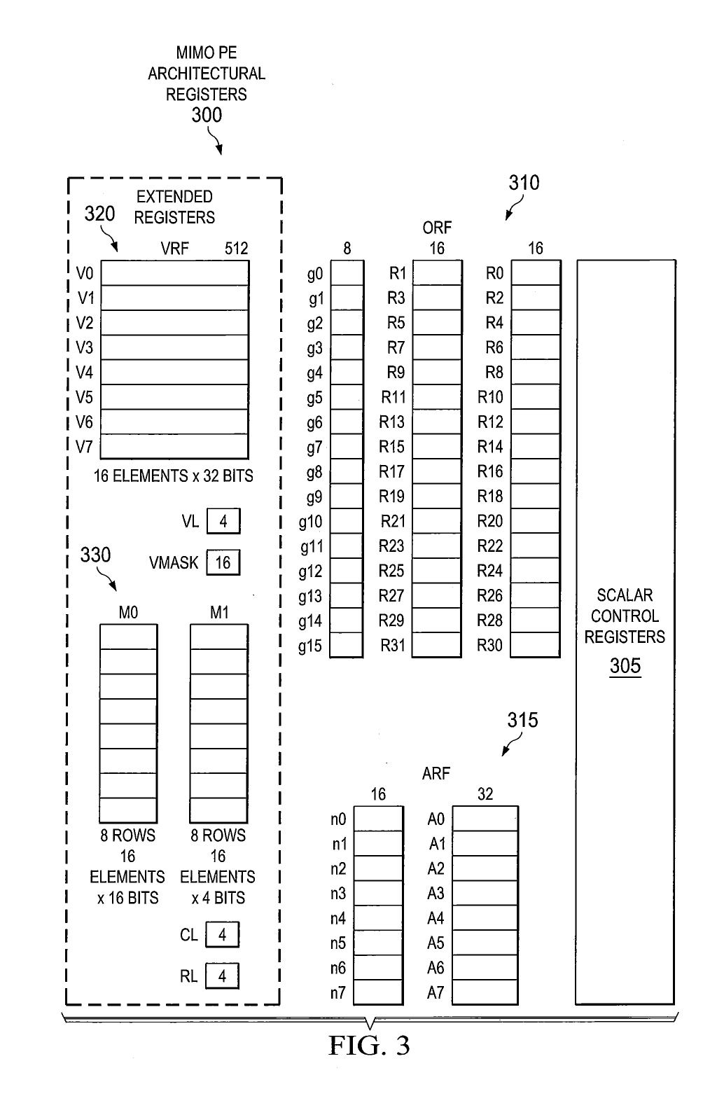

FIG. 3 illustrates a diagram of a logical representation of architectural registers in a data processor element constructed according to the principles of the present disclosure;

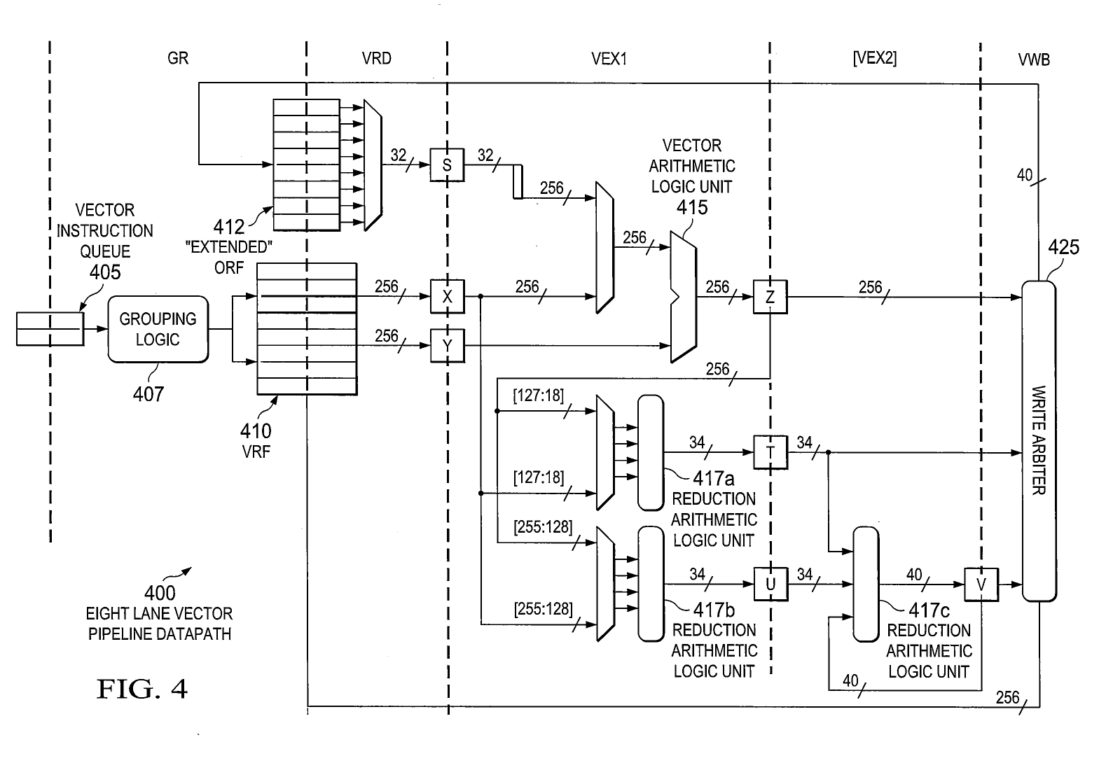

FIG. 4 illustrates a more detailed diagram of an embodiment of a vector processing unit as may be employed in the data processing elements of FIGS. 1 and 2;

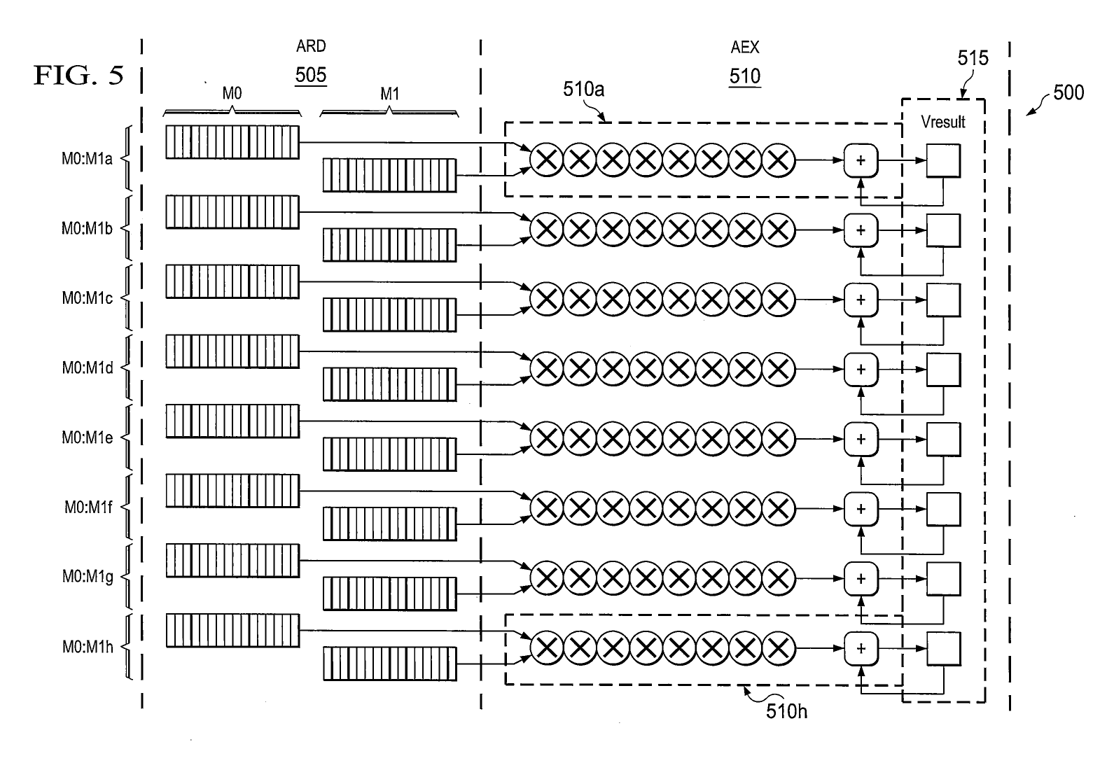

FIG. 5 illustrates a more detailed diagram of an embodiment of a portion of an array processing unit as may be employed in the data processing elements of FIGS. 1 and 2;

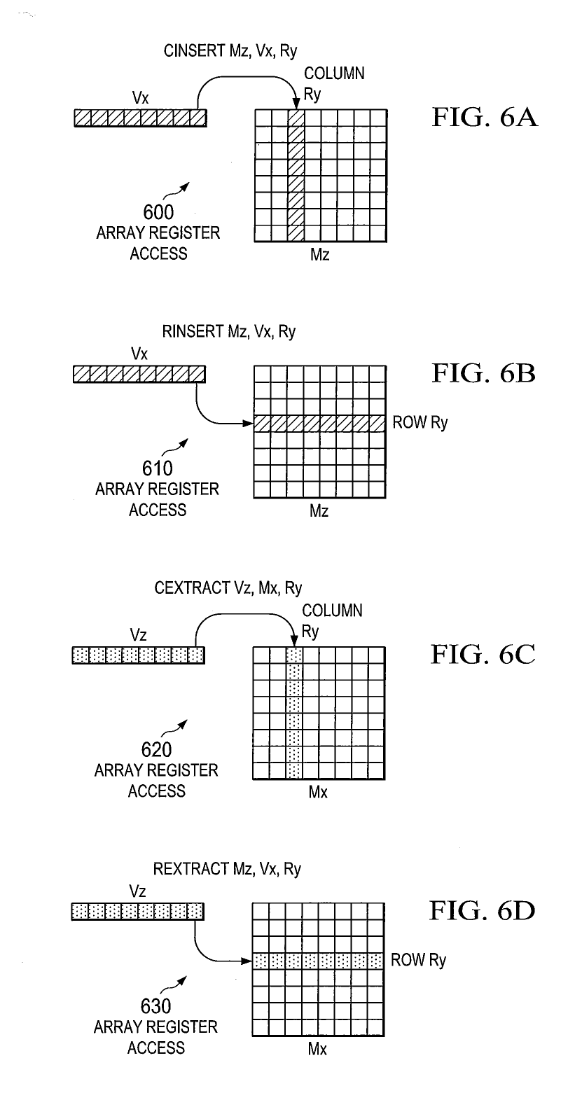

FIGS. 6A, 6B, 6C and 6D illustrate array read stages showing a capability of vector registers in a vector register file to be inserted into or extract from array (matrix) registers; and

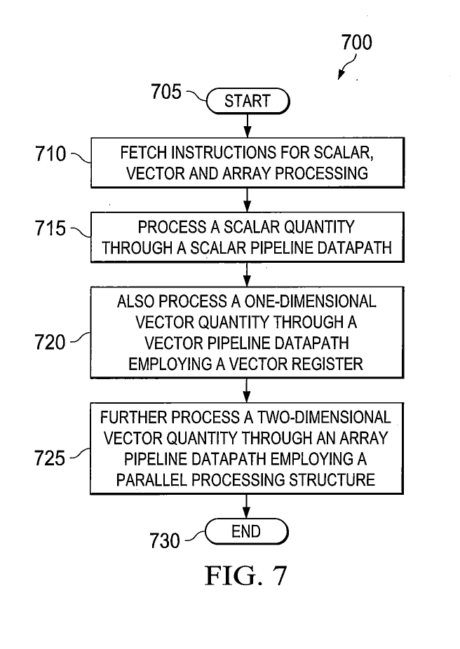

FIG. 7 illustrates a flow diagram of a method of operating a data processing element carried out according to the principles of the present disclosure.

### DETAILED DESCRIPTION

FIG. 1 illustrates a diagram of a MIMO system, generally designated 100, constructed according to the principles of the present disclosure. The MIMO system 100 includes a MIMO transmitter 105 having an input bitstream Bin on a transmitter input 107 and N transmit antennas Tₓ₁, Tₓ₂, . . . , T_{xN}. The MIMO system 100 also includes a MIMO receiver 110 having N receive antennas Rₓ₁, Rₓ₂, . . . , R_{xN}, input elements 120, a data processing element 125 and output elements 140 that provide an output bitstream Bout on a receiver output 142.

Generally, the transmitter 105 encodes the input bitstream Bin and demultiplexes it for concurrent transmission by the N transmit antennas Tₓ₁, Tₓ₂, . . . , T_{xN} to the N receive antennas Rₓ₁, Rₓ₂, . . . , R_{xN}. Typically, independent data signals {xᵢ} (e.g., x₁, x₂, . . . , x_{N}) are transmitted concurrently on corresponding N transmit antennas Tₓ₁, Tₓ₂, . . . , T_{xN}. Combined receive signals {rⱼ} (i.e., r₁, r₂, . . . r_{N}) are received by each of the N receive antennas Rₓ₁, Rₓ₂, . . . , R_{xN}, which may be represented by the equation set (1), below.

$$\begin{matrix}{r}_{1} = {h}_{11} {x}_{1} + {h}_{12} {x}_{2} + … + {h}_{1 N} {x}_{N} \\ {r}_{2} = {h}_{21} {x}_{1} + {h}_{22} {x}_{2} + … + {h}_{2 N} {x}_{N} \\ ⋮ \\ {r}_{N} = {h}_{N 1} {x}_{1} + {h}_{N 2} {x}_{2} + … + {h}_{NN} {x}_{N}\end{matrix} \qquad ( 1 )$$

Here, the coefficients hᵢⱼ, representing individual channel weights, form a channel matrix H as represented in the equation (2) below.

$$H = ( \begin{matrix}{h}_{11} & {h}_{12} & … & {h}_{1 N} \\ {h}_{21} & {h}_{22} & … & {h}_{2 N} \\ ⋮ & & & \\ {h}_{N 1} & {h}_{N 2} & … & {h}_{NN}\end{matrix} ) . \qquad ( 2 )$$

The channel matrix H allows recovery of the independent data signals {xᵢ} from the combined receive signals {rⱼ} at the receiver 110. To recover the independent data signals {xᵢ} from the combined receive signals {rⱼ}, the individual channel weights hᵢⱼ are estimated and the channel matrix H is constructed. Then, multiplication of a receive vector r with the inverse of the channel matrix H provides an estimate of the corresponding transmitted vector x.

The input elements 120 accept the combined receive signals {rⱼ} at the receiver 110 and format them for processing by the data processing element 125. The output elements 140 accept processed values of estimated transmit values from the data processing element 125 and provide the output bitstream Bout, which is a reconstruction of the input bitstream Bin.

The data processing element 125 illustrates a top-level hierarchy and includes an input unit (IU) 127 (i.e., an instruction fetch front end), a scalar processing unit (SPU) 131, a vector processing unit (VPU) 133 and an array processing unit (APU) 136. The IU 127 contains a 64-bit instruction fetch interface and dispatches instructions to one of the three execution units (i.e., the SPU 131, the VPU 133 and the APU 136).

All scalar, control (branches), and load/store instructions are dispatched to the SPU 131. This unit contains one 256-bit load/store interface, which is used to service both scalar and vector load/store requests. Vector instructions are dispatched to the VPU 133, and array instructions are dispatched to the APU 136. The APU 136 acts as an efficient datapath for code that is vectorizable. In this embodiment, the APU 136 provides a specialized datapath targeted for parallel multiply/accumulate (MAC) operations. The VPU 133 and the APU 136 do not process control or memory access functions.

FIG. 2 illustrates a pipeline diagram of a data processing element, generally designated 200, as may be employed in the data processing element 125 of FIG. 1. The pipeline diagram of the data processing element 200 provides a more detailed representation and includes an input unit (IU) 205 that operates as a consolidated instruction fetch front-end and services a scalar pipeline unit (SPU) 215, a vector pipeline unit (VPU) 225 and an array pipeline unit (APU) 235, as shown. The data processing element 200 is a two-issue machine, but issue width to each pipe is limited, as shown in Table 1.

TABLE 1
Issue Width to Each Pipe

| Pipe | Issue Width |
|---|---|
| Scalar | 2 |
| Vector | 1 |
| Array | 1 |

The IU 205 provides pipelined instructions for the SPU 215, the VPU 225 and the APU 235, which generally include fetch, decode, execute and write-back instructions. The IU 205 employs prefetch stages PF0, PF1, PF2, PF3 and a fetch/decode stage (F/D) that include an instruction address request register (reqi_addr), an instruction cache (Icache), a prefetch buffer (pfu buffer), a prefetch queue (pfu queue) and a fetch/decode (F/D) module.

The prefetch stage PF0 employs a program counter (PC) that provides a currently pointed-at instruction address to the register (reqi_addr). Then, in the prefetch stage PF1, the register (reqi_addr) accesses the instruction address from the instruction cache (Icache). The instruction address is then written into the local prefetch buffer (pfu buffer) in the prefetch stage PF2. The prefetch stage PF3 is a predecode stage that employs the prefetch queue (pfu queue). Instruction processing starts in the fetch/decode stage (F/D) employing the fetch/decode (F/D) module to provide a decoded instruction for the SPU 215, the VPU 225 or the APU 235.

The SPU 215 provides a scalar pipeline datapath for scalar data employing a collection of registers and includes a scalar instruction queue (scalar queue) along with stages corresponding to scalar grouping (GR), scalar read (RD), address generation (AG), first and second data memory (DM0, DM1), execute (EX) and write-back (WB).

From the scalar instruction queue (scalar queue), the instruction is grouped in the scalar grouping (GR) stage, which puts as many instructions together as possible without having dependencies and branches thereby determining how many instructions can be executed together in one packet. The scalar read (RD) stage reads operands from associated registers and provides temporary, fast and local storage for the instruction being specified.

The address generation (AG) stage provides for memory access, which is usually provided based on a register value that acts as a data pointer to provide a new data pointer value (memory address) in the first data memory (DM0) stage thereby returning the addressed data to the second data memory DM1 stage. The VPU 225 also depends on the data access structure employed in the SPU 215. The execute (EX) stage is employed for processing the addressed data using computational arithmetic logic units, multipliers, etc. The computational results are written into registers in the write-back (WB) stage.

The VPU 225 provides a vector pipeline datapath for vector data (i.e., one-dimensional vectors) and is somewhat simpler in that it does not deal with loading from external memory, branching or the more complicated operations of the SPU 215. The VPU 225 is basically an execution engine and includes a vector instruction queue (vector queue) along with stages corresponding to vector grouping (GR), vector read (VRD), first and optional second vector execute (VEX1, VEX2) and vector write-back (VWB).

The vector grouping (GR) stage organizes the number of vector instructions that can be grouped together thereby paralleling the operation of the scalar grouping (GR) stage. In the illustrated embodiment, only one vector instruction can be grouped (i.e., only the next vector instruction). In the vector read (VRD) stage, one-dimensional vector register files (corresponding to one of eight vector register files V0 through V7) are read and loaded into the first vector execute (VEX1) stage. In the first vector execute (VEX1) stage, register operands are employed for computational processing of these vector register files. The optional second vector execute (VEX2) stage may be required for some cases of computational processing. When execution of the vector register files is complete, the results are written into a register in the vector write-back (VWB) stage, for further processing.

The APU 235 provides an array pipeline datapath for array data (i.e., two-dimensional vectors) and includes an array instruction queue (array queue) along with stages corresponding to array grouping (GR), array read (ARD), array execute (AEX) and array write-back (AWB). The array grouping (GR) stage provides instruction grouping for array data wherein only one array instruction can be grouped, similar to the vector grouping (GR) stage, in the illustrated embodiment.

The array read (ARD) stage shown employs an eight by eight read array of two-dimensional vectors, which corresponds to a maximum number of MIMO transmit and receive antennas that may be employed in an LTE (Long Term Evolution) Advanced system. In general, other read array sizes may be employed as appropriate to a particular MIMO system requirement. The array execute (AEX) stage is an eight by eight parallel multiplier that matches the eight by eight read array (ARD) shown and may also be provided to match the requirements of another particular MIMO system. The array execute (AEX) stage provides a resultant one-dimensional vector to the array write-back (AWB) stage, for further processing.

The APU 235 can generally be configured to accommodate the reading and processing of two matrix quantities (i.e., a pair of two-dimensional quantities) with a resultant two-dimensional quantity, as appropriate to a system requirement. In the illustrated embodiment of MIMO detection, the APU 235 is typically employed to multiply a matrix (a two-dimensional quantity) by a vector (a one-dimensional quantity) and obtain a single vector result (a one-dimensional quantity).

FIG. 3 illustrates a diagram of a logical representation of architectural registers in a data processor element, generally designated 300, constructed according to the principles of the present disclosure. The logical representation of architectural registers 300 illustrates salient registers contained in scalar, vector and array processing units such as those previously discussed. The architectural registers 300 shown may employ an extension of a G3 register interface where the number of general purpose registers has been doubled, and a new vector register file has been added with specialized array processing extensions.

The architectural registers 300 include scalar control registers 305, operand register files (ORF) 310 and address register files (ARF) 315, which are legacy general purpose scalar registers. The architectural registers 300 are extended to include a one-dimensional vector register file 320 and a two-dimensional vector array register file 330.

In the illustrated embodiment, the one-dimensional vector register file 320 includes eight separate one-dimensional vector registers V1-V7 (i.e., V0, V1, V2, V3, V4, V5, V6 and V7), where each of the vector registers (V0-V7) contains 16 32-bit elements. The vector register file 320 also includes a vector length register VL and a vector mask register VMASK. Each of the vector registers V0-V7 executes in one clock cycle, and vector addition of any two of these vector registers (e.g., V0 and V1) can be done in parallel.

The vector length register VL may be employed to determine an active length of at least one of the vector registers V0-V7 when its total available length is not required. This feature saves power by only activating the portions required (i.e., only those registers or register portions that contribute to a final answer). Additionally, deactivation of the clock signal to unused registers or register portions may also be employed. The vector mask register VMASK indicates which individual elements are to be updated.

The two-dimensional vector array register file 330 includes a pair of two-dimensional vector registers M0, M1 along with a column length register CL and a row length register RL that are employed for array processing. The registers M0 contain eight rows of registers, where each row is composed of 16 elements employing 16-bits each. The registers M1 contain eight rows of registers, where each row is composed of 16 elements employing 4-bits each. In the illustrated MIMO embodiment of FIG. 1, the registers M0 may be employed to store channel matrix information, and the registers M1 may be employed for storing search vectors.

A unique feature of the array datapath is the manner in which it communicates with the vector and scalar datapaths. It is possible to write to or read from any row or column of the array registers M0, M1. Registers M0 and M1 can be multiplied together in parallel in one clock cycle. Also, the result of an array operation may be forwarded directly to a VEX1 stage of a vector pipeline unit.

The column length and row length registers CL, RL may be employed to determine a subset of the total available array size (e.g., an ARD size) to be used in array processing. They determine which of the small squares (or rectangles) shown will perform operations. Additionally, they may determine which subset of a corresponding array multiplier is to be employed (e.g., multiplier block sizes of 4×4, 8×8, 16×16, etc.).

FIG. 4 illustrates a more detailed diagram of an embodiment of a vector processing unit, generally designated 400, as may be employed in the data processing elements 125 and 200 of FIGS. 1 and 2. The vector processing unit (VPU) 400 is organized into the pipeline stages discussed with respect to FIG. 2 and includes a vector instruction queue 405, grouping logic 407, a vector register file (VRF) 410, an extended operand register file (ORF) 412, a vector arithmetic logic unit (VALU) 415, first, second and third reduction arithmetic logic units (RALUs) 417a, 417b, 417c and a write arbiter 425.

The VPU 400 is a baseband processor datapath containing an eight lane vector pipeline. The datapath consists of two types of execution units which are the VALU 415 and the RALUs 417a, 417b, 417c. The VALU 415 employs two vectors as inputs (one from the VRF 410 and the other from the extended ORF 412) and produces a single vector result. It contains eight separate lanes, each of which can be clock-gated depending on a vector length (VL) register value. The ability to gate off lanes is important to power minimization when less than the full vector length is employed, as noted above. Each of the RALUs 417a, 417b, 417c employs a four element vector as its input and produces a scalar result. Examples of reduction operations include finding the minimum or maximum element of a vector or finding the sum of the elements of a vector. Two stages of reduction are required for vector lengths greater than four. The write arbiter 425 provides write-back to the VRF 410 and the extended ORF 412, as shown.

FIG. 5 illustrates a more detailed diagram of an embodiment of a portion of an array processing unit, generally designated 500, as may be employed in the data processing elements 125 and 200 of FIGS. 1 and 2. The array processing unit (APU) 500 portion shown includes array read (ARD) and array execute (AEX) stages (i.e., ARD 505 and AEX 510) of an array datapath. Logically, the array datapath can be thought of as eight lanes of eight parallel multiplying accumulators that are controlled by a single command (a 64-way SIMD).

The ARD 505 includes first and second two-dimensional vector (matrix) storage registers M0, M1, which exist in the APU 500 itself. The AEX 510 includes eight parallel multiplying accumulators 510a through 510h where each provides eight parallel multiplying operations. Each of the two-dimensional vector storage registers M0, M1 contains eight rows of registers where each row is composed of sixteen elements. Corresponding rows (i.e., M0:M1a-M0:M1h) of the first and second storage registers M0, M1 are paired with one of the eight parallel multiplying accumulators (510a-510h) to provide the array datapath of eight lanes, as shown.

In the ARD 505 of the illustrated embodiment, the first two-dimensional register M0 is an array having eight rows of 16 elements consisting of 16 bits each, and the second two-dimensional register M1 is an array having eight rows of 16 elements consisting of four bits each. Correspondingly, the AEX 510 corresponds to 64 multiplying accumulator elements of 16 bits times four bits that provide eight 24 bit resultant vectors (Vresult) 515.

When employed in MIMO detection, the register M0 may have the same vector value in each of its rows while the register M1 may have a different vector value in each of its rows while employing the AEX 510 for multiplication and accumulation. Alternately, the register M0 may contain an actual matrix (an actual two-dimensional structure) while the register M1 contains a one-dimensional vector to be multiplied and accumulated. For example, the higher precision matrix register M0 can be used to store channel matrix information, while the matrix register M1 is used to store search vectors. These structures provide the versatility to do the two main types of “tree” searches (breadth-first or depth-first) that are typically done in MIMO detection.

For the breadth-first approach, a row in the registers M0 would represent the top of the tree. A triangular matrix is a preprocessed matrix that represents antenna gains (i.e., the gains between one set of transmit antennas and receive antennas). At the bottom of the triangle matrix, the row in registers M0 contains one gain value and the rest zeros. Correspondingly, a row in registers M1 has all zeros except for that one last element.

The array datapath offers increased processing speed that occurs by employing up to eight different symbol values in the registers M1 (e.g., symbol values of A, B, C, D, E, F, G or H). Then, all these combinations are multiplied yielding eight different results, which are placed in the register Vresult 515, shown in FIG. 5. In this example there are only eight multiplications occurring in parallel rather than the 64 multiplications possible in the AEX 510. When the registers M0 are fully populated (e.g., at the bottom of the tree corresponding to the top of the triangle matrix) and the registers M1 are fully populated, there are 64 multiplications occurring in parallel at the same time.

Here, a column insert feature of the ARD 505 becomes very useful. When the transmitted symbol values begin to stabilize during the detection process, the upper elements in each of those rows become pretty well fixed. This allows addressing those bottom elements and making them all zeros except for that one last element symbol value of A, B, C, D, E, F, G or H again, for example. There are eight different calculations occurring at the same time that generally provide eight different results, which is to say that there are eight different results based on eight different symbols that were transmitted.

There is a scalar register in the SPU 215, for example, that allows comparison of the eight different results in the VPU 225 with the symbol that was actually received at this level. There is a vector of results that requires comparison corresponding to which of these eight results most closely matches the actual symbol that was received, wherein the actual symbol received is stored in the scalar register file. A vector subtract instruction for this result with the actual received symbol in the scalar register provides a difference vector containing all of the differences, wherein the lowest difference may be chosen thereby providing the smallest error between what was transmitted and received.

An example of the cross-pipeline interactions and communications that occur is when a vector minimum instruction is employed to provide this lowest difference, as noted above. The vector minimum instruction employs the reduction operators (e.g., the RALUs 417a, 417b, 417c) in the VPU 225 that may require multiple stages to find the minimum.

Generally, in embodiments of data processing elements constructed according to the principles of the present disclosure, an APU provides the extensive array processing required, a VPU determines resulting errors between calculated and actual results and an SPU accommodates everything else including control and data memory operations.

FIGS. 6A, 6B, 6C and 6D illustrate array read stages, generally designated 600, 610, 620 and 630, showing a capability of vector registers in a vector register file to be inserted into or extract from array (matrix) registers. That is, any one of the one-dimensional vectors V0-V7 may be inserted into or extracted from any column or any row of the ARDs 600, 610, 620, 630 employing array registers M0 or M1.

As an example of MIMO antenna processing, assume that columns to the right of the column Ry have already been processed and resolved. That is, processing from the bottom of a triangular gain matrix has determined a best estimate of the transmitted symbol for a particular row (level). Then, the next-best and so on has been determined until column Ry is being addressed to determine an error at this level. For a worst case modulation scheme of QAM 64, the vector in column Ry may contain a very simple algorithm of symbol values A, B, C, D, E, F, G or H, as before.

There are more complicated algorithms that use a number of complex values along with additional complex values earlier up within the other columns. For example, in a detection search, a sphere decoder starts with an initial value and then searches nearby within a sphere radius employing symbols that attempt to fine tune the initial value.

Define column one as the right column and column eight as the left column in FIG. 6A. An initial estimate corresponding to a transmitted symbol is populated into this register. Then a few register values may be changed in column two that correspond to a plus or minus distance from the initial estimate, in a search range. Additionally, some register values may be changed in column four that correspond to the same or another plus or minus distance from the initial estimate. These are then employed to obtain search errors (difference values), as before.

One skilled in the pertinent art recognizes the enhanced flexibility afforded by this general approach for detection algorithm generation and application as compared to a hardwired detection scheme. Particular embodiments of the present disclosure employing an APU coupled to a VPU and an SPU in one data processing element accommodate detection schemes that may be generated, tailored or adapted to current and future systems and situations. Additionally, data processing elements employing an APU coupled to a VPU and an SPU in one processing element has utility beyond MIMO systems.

FIG. 7 illustrates a flow diagram of a method of operating a data processing element, generally designated 700, carried out according to the principles of the present disclosure. The method 700 starts in a step 705. Then, in a step 710, instructions for scalar, vector and array processing are fetched, and a scalar quantity is processed through a scalar pipeline datapath, in a step 715. A one-dimensional vector quantity is also processed through a vector pipeline datapath employing a vector register, in a step 720, and a two-dimensional vector quantity is further processed through an array pipeline datapath employing a parallel processing structure, in a step 725.

In one embodiment, the parallel processing structure includes a two-dimensional vector register for processing the two-dimensional vector quantity. In one case, a one-dimensional vector quantity can be inserted separately and directly into the two-dimensional register on a row-wise or a column-wise basis. In another case, a one-dimensional vector quantity can be extracted separately and directly from the two-dimensional register on a row-wise or a column-wise basis. In either of these cases, the one-dimensional vector may be associated with the vector pipeline datapath.

In another embodiment, the parallel processing structure includes a parallel multiplying accumulator for processing the two-dimensional vector quantity. In yet another embodiment, the parallel multiplying accumulator provides a resultant one-dimensional vector quantity. In a further embodiment, the resultant one-dimensional vector quantity is processed in the vector pipeline datapath. The method 700 ends in a step 730.

While the method disclosed herein has been described and shown with reference to particular steps performed in a particular order, it will be understood that these steps may be combined, subdivided, or reordered to form an equivalent method without departing from the teachings of the present disclosure. Accordingly, unless specifically indicated herein, the order or the grouping of the steps is not a limitation of the present disclosure.

Those skilled in the art to which this application relates will appreciate that other and further additions, deletions, substitutions and modifications may be made to the described embodiments.

What is claimed is:

1. A data processing element, comprising:
an input unit configured to provide instructions for scalar, vector and array processing;
a scalar processing unit configured to provide a scalar pipeline datapath for processing a scalar quantity;
a vector processing unit coupled to the scalar processing unit and configured to provide a vector pipeline datapath employing a vector register for processing a one-dimensional vector quantity; and
an array processing unit coupled to the vector processing unit and configured to provide an array pipeline datapath employing a parallel processing structure for processing a two-dimensional vector quantity.

2. The data processing element as recited in claim 1 wherein the parallel processing structure includes a two-dimensional vector register for processing the two-dimensional vector quantity.

3. The data processing element as recited in claim 2 wherein a one-dimensional vector quantity can be inserted separately and directly into the two-dimensional register on a row-wise or a column-wise basis.

4. The data processing element as recited in claim 2 wherein a one-dimensional vector quantity can be extracted separately and directly from the two-dimensional register on a row-wise or a column-wise basis.

5. The data processing element as recited in claim 1 wherein the parallel processing structure includes a parallel multiplying accumulator for processing the two-dimensional vector quantity.

6. The data processing element as recited in claim 5 wherein the parallel multiplying accumulator provides a resultant one-dimensional vector quantity.

7. The data processing element as recited in claim 6 wherein the resultant one-dimensional vector quantity is processed in the vector pipeline datapath.

8. A method of operating a data processing element, comprising:
fetching instructions for scalar, vector and array processing;
processing a scalar quantity through a scalar pipeline datapath;
also processing a one-dimensional vector quantity through a vector pipeline datapath employing a vector register; and
further processing a two-dimensional vector quantity through an array pipeline datapath employing a parallel processing structure.

9. The method as recited in claim 8 wherein the parallel processing structure includes a two-dimensional vector register for processing the two-dimensional vector quantity.

10. The method as recited in claim 9 wherein a one-dimensional vector quantity can be inserted separately and directly into the two-dimensional register on a row-wise or a column-wise basis.

11. The method as recited in claim 9 wherein a one-dimensional vector quantity can be extracted separately and directly from the two-dimensional register on a row-wise or a column-wise basis.

12. The method as recited in claim 8 wherein the parallel processing structure includes a parallel multiplying accumulator for processing the two-dimensional vector quantity.

13. The method as recited in claim 12 wherein the parallel multiplying accumulator provides a resultant one-dimensional vector quantity.

14. The method as recited in claim 13 wherein the resultant one-dimensional vector quantity is processed in the vector pipeline datapath.

15. a MIMO receiver, comprising:
a MIMO input element, coupled to multiple receive antennas, that provides receive data for scalar, vector and array processing;
a data processing element, including:
an input unit that provides instructions for the scalar, vector and array processing,
a scalar processing unit that provides a scalar pipeline datapath for processing scalar data,
a vector processing unit, coupled to the scalar processing unit, that provides a vector pipeline datapath employing a vector register for processing one-dimensional vector data, and
an array processing unit, coupled to the vector processing unit, that provides an array pipeline datapath having a parallel processing structure for processing two-dimensional vector data; and
a MIMO output element, coupled to the data processing element, that provides an output data stream corresponding to the receive data.

16. The receiver as recited in claim 15 wherein the parallel processing structure includes a two-dimensional vector register for processing the two-dimensional vector data.

17. The receiver as recited in claim 16 wherein one-dimensional vector data can be inserted separately and directly into the two-dimensional register on a row-wise or a column-wise basis.

18. The receiver as recited in claim 16 wherein one-dimensional vector data can be extracted separately and directly from the two-dimensional register on a row-wise or a column-wise basis.

19. The receiver as recited in claim 15 wherein the parallel processing structure includes a parallel multiplying accumulator for processing the two-dimensional vector data.

20. The receiver as recited in claim 19 wherein the parallel multiplying accumulator provides resultant one-dimensional vector data.
